(19) United States
(12) Patent Application Publication
(10) Pub. No.: US 2008/0085170 A1
(43) Pub. Date: Apr. 10, 2008

(54) Locking assembly

(75) Inventor: Chun-Ying Yang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/544,742

(22) Filed: Oct. 10, 2006

(51) Int. Cl. F16B 21/18

(52) U.S. Cl. 411/353

(57) ABSTRACT

A locking assembly used for fixing an object to a frame is provided. In the locking assembly, a gasket and an elastic component are fit on a connector, and the gasket and the frame have a corresponding retaining mechanism. After the locking assembly passes through the frame and the object, the locking assembly is prevented from slipping and loosening by the retaining mechanism.

### BACKGROUND OF THE INVENTION

1. Field of Invention

The present invention relates to a locking assembly, and more particularly, to a locking assembly installed on the frame of a server for fixing an electronic apparatus.

2. Related Art

To meet the rapid development and popularization of the network system, hosts are integrated and managed by a server, such that each host can serve various terminals in the network system, so as to serve the designated different user groups, and to be responsible for managing and harmonizing the files and web site content required by each user to achieve resource sharing.

Therefore, the server requires a large quantity of external connecting equipments. As for an Xeon™ level server, the network bandwidth has developed to the Gigabit Ethernet which is 100 times of that of a personal computer; the small computer system interface (SCSI) connection is a standard outfit, which is rarely seen in a personal computer; the server can be further connected to a disk array system which can connect more than eight hard disks of large capacity in series at a sitting, and the above outfits cannot be found in a personal computer. Generally speaking, the server or other removable computer peripheral equipments that can integrate various hosts combines many kinds of expansion apparatuses. Therefore, in order to firmly fix the expansion apparatuses in the server, a locking assembly, for example, screw, is required to prevent the expansion apparatuses from falling off the server.

The expansion apparatus slips into the frame along a chute disposed in the frame via a slipper, and then passes through the locking assembly from the fame of the server to fix the expansion apparatus. However, during the transport process of the server, the locking assembly may be affected by the impacting external force to cause loosening, thus resulting in damage to the frame and the expansion apparatus. Therefore, in order to resist the impacting force during the transport process, the quantity of the locking assembly fixed to the frame is increased. However, the production cost of the locking assembly is high and the time taken by locking is also increased due to its insufficiency in strength.

Please refer to FIG. 1 of an assembly view of a locking assembly according to the conventional art. As shown in FIG. 1, a connector 21a is installed on a frame 31a of a server 30a, and is near a crossing bridge 32a. The crossing bridge 32a is used to assist the positioning of the connector 21a. A cap portion 22a of the connector 21a has a large locking area and thus can be supported against the frame 31a after locking, such that the frictional force of locking is increased to resist the impacting force during the transport process. However, once affected by the impacting force, the above design can only limit the displacement of the cap portion 22a of the connector 21a in the penetration direction, and the cap portion 22a can still slip along the surface of the frame 31a, so the connector 21a cannot be completely fixed. If the impacting force is relatively powerful, the frame 32a is easy to be damaged. Therefore, how to entirely limit the moving freedom of the connector 21a in three moving directions to avoid loosening when affected by the impacting external force has become a technical subject to be solved urgently.

### SUMMARY OF THE INVENTION

The conventional locking assembly is outrageous in cost and cannot endure the impacting external force during the transmitting process. Thus, the present invention provides a locking assembly to effectively improve the non-slip force of the locking assembly and meanwhile to reduce the cost.

To achieve the above objective, the present invention provides a locking assembly for fixing an object to a frame, wherein the frame has a slip stopper. The locking assembly comprises a gasket and a connecter. The gasket has a stopper that can be supported against the connector, and the stopper has a buckling portion that can retain by cooperation of the slip stopper. The connector has a cap portion and a thread portion extending from the adjacent end of the cap portion. The thread portion is used to pass through the gasket and then through the frame and the object after the gasket combines the connector, so as to make the buckling portion retain the slip stopper. As such, the locking assembly may not fall off and thus fix the object.

The function of the locking assembly disclosed in the present invention is that the gasket combines the connector and passes through the frame as the gasket has a retaining mechanism matching the frame, such that the displacement of the connector is truly limited in three moving directions to avoid falling off. Moreover, the gasket can increase the packing power of the connector and enhance the mechanical performance of the cap portion of the connector, such that the elastic resistance is maintained between the cap portion and the frame, thereby increasing the tolerance of the connector when affected by the impacting external force and prolonging the service life of the connector. The gasket is located between the cap portion and the frame to protect the surface of the frame, such that when affected by the impacting force, the connector may not cause damage to the frame. Meanwhile, as for the impacting endurance, the above structural design is simple and the production cost is reduced.

The detailed features and advantages of the present invention are discussed in detail in the following embodiments. Anybody skilled in the related arts can easily understand and implement the content of the technology of the present invention. Furthermore, the relative objectives and advantages of the present invention are apparent to those skilled in the related arts according to the content disclosed in the specification, claims and drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an assembly view of a conventional locking assembly;

FIG. 2 is a view of a locking assembly according to a first embodiment of the present invention;

FIGS. 3 and 4 are schematic views of the assembly of the first embodiment of the present invention;

FIG. 5 is schematic view of an assembly process according to the first embodiment of the present invention; and

FIG. 6 is a schematic view of the assembly of a second embodiment of the present invention.

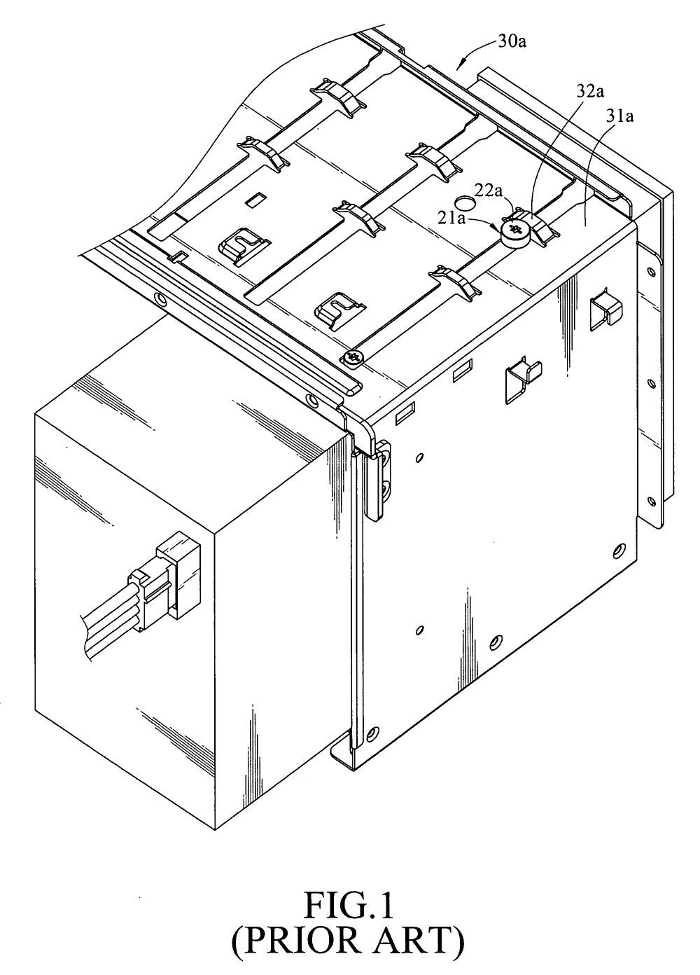

### DETAILED DESCRIPTION OF THE INVENTION

To acquire further understandings to the objectives, structure, features and functions of the present invention, they are illustrated in detail below with reference to the related embodiments and drawings.

According to the locking assembly disclosed in the present invention, an object is fixed to the frame, wherein the object can be, but not limited to, a tape unit or an optical disk drive and so on. For example, any electronic apparatus that can read and store data may adopt the technique disclosed in the present invention. Moreover, the frame may be the frame of a server or the case of a personal computer, and is used to fix the mentioned electronic apparatus. In the following detailed description of the present invention, the frame of the server with a tape unit fixed thereon serves as the application embodiment of the present invention.

As the server combines many kinds of expansion apparatuses, in order to effectively fix the expansion apparatuses in the server, the locking assembly is required, for example, screw, to prevent each expansion apparatus from falling off the server and to ensure the electrical connection between each expansion apparatus and the server. However, as the locking assembly is installed on the frame of the server with the nut protruding out, during the transport process of the server, the impacting force may be directly exerted on the nut, thus making the locking assembly slip and loosen, which may result in damage to the frame and the expansion apparatus. Therefore, in order to settle the above problem, the present invention provides a locking assembly to solve the slipping of the locking assembly.

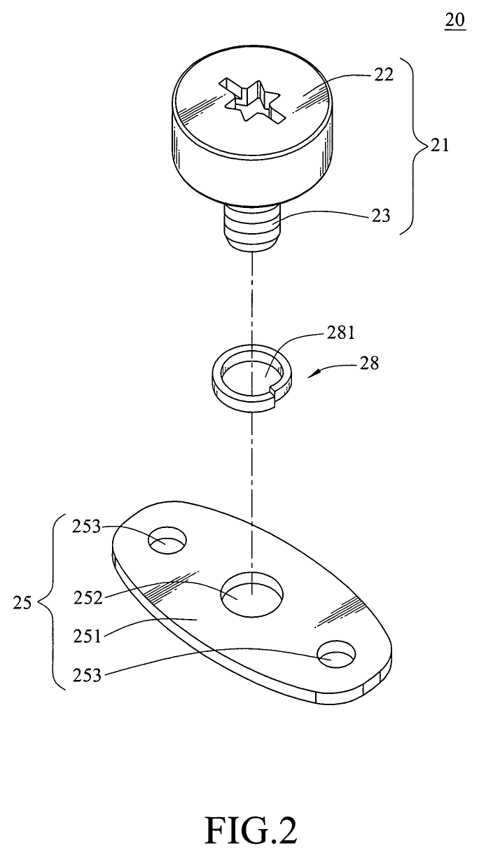

Please refer to FIG. 2 of an assembly view of the locking assembly according to the first embodiment of the present invention. As shown in FIG. 2, the locking assembly 20 includes a connector 21 and a gasket 25. The connector 21 and the gasket 25 can be fabricated as one piece, or as independent elements. Here, the connector 21 and the gasket 25 are two independent elements. The connector 21 has a cap portion 22 and a thread portion 23 extending from the adjacent end of the cap portion 22. The thread portion 23 is formed with thread and serves as the penetration position of the connector 21. Moreover, the diameter of the cap portion 22 is longer than that of the thread portion 23 and the diameter of the gasket 25 is longer than that of the cap portion 22. The gasket 25 has a stopper 251 and a through hole 252, wherein the through hole 252 is fit on the thread portion 23 of the connector 21, so as to make the gasket 25 combine the connector 21, and together pass through the target. After passing through, the stopper 251 lies between the target and the cap portion 22. Moreover, a buckling portion 253 is disposed on the stopper 251 corresponding to the through hole 252, and in the first embodiment, the buckling portion 253 is two positioning holes used for retaining the target to make the connector 21 have the non-slip and positioning function after locking.

As the connector 21 is locked by an externally applied locking force, after the force is removed, the connector 21 may appreciably loosen due to the reactive force generated by the locking force. Therefore, to prevent loosening, an elastic component 28 may be fit between the cap portion 22 and the gasket 25 of the connector 21. At this time, the elastic component 28 can be supported against the connector 21, so as to alleviate the effect of the reactive force and to prevent the connector 21 from loosening. The elastic component 28 has a through hole 281 fit on the thread portion 23.

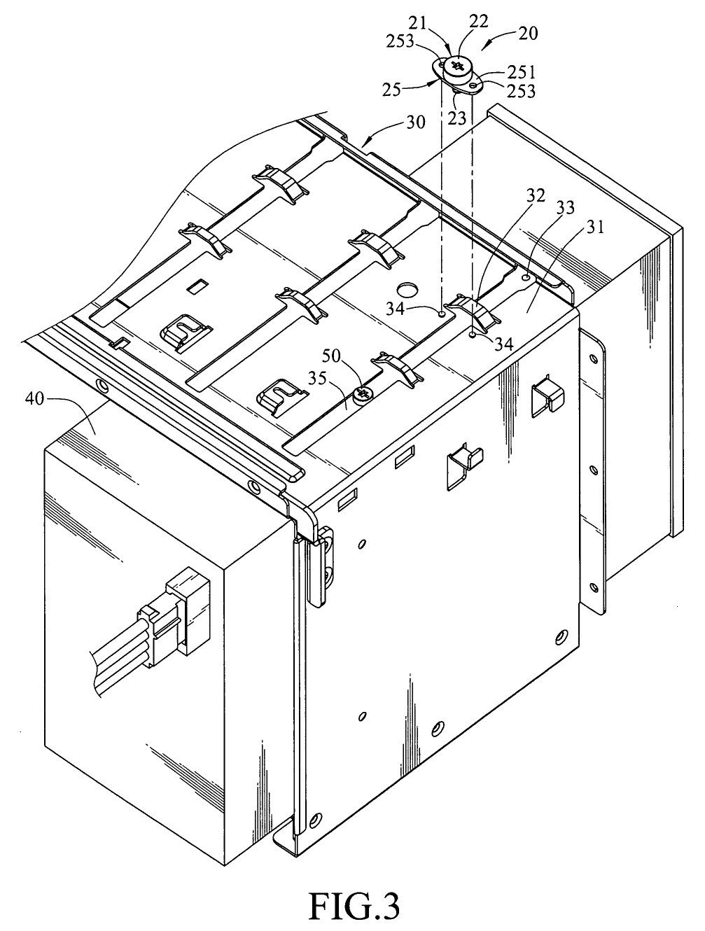

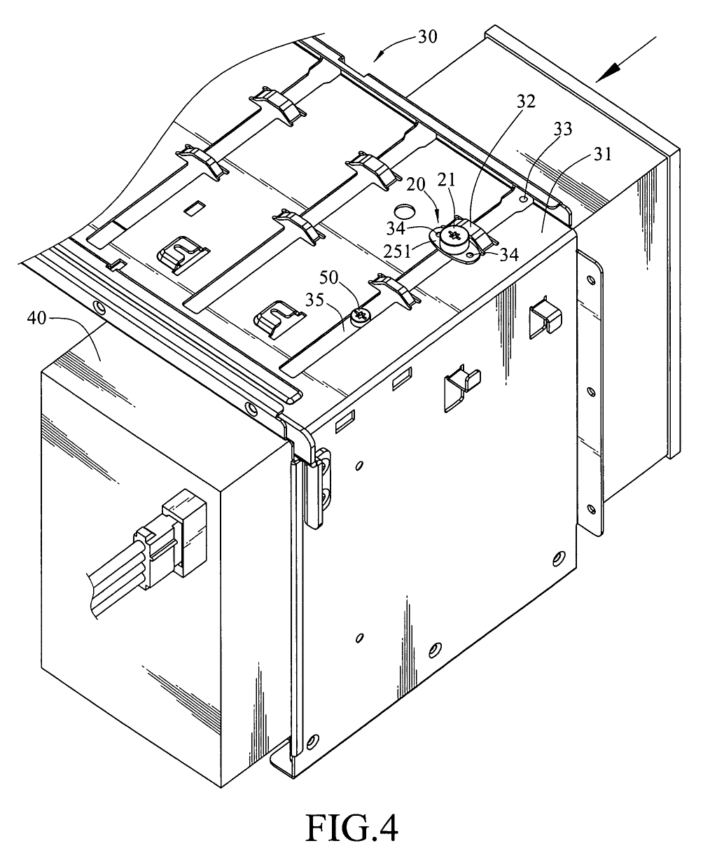

Please refer to FIGS. 3 and 4 of schematic views of the assembly of the first embodiment of the present invention. As shown in FIGS. 3 and 4, the frame 31 of the server 30 is used to carry and position a tape unit 40. The tape unit 40 having a through hole 33 can slip or be positioned in the frame 31 by a slipper 50, and is electrically connected to the server 30 to perform operation and command control. The frame 31 has a crossing bridge 32, a slip stopper 24 and a chute 35, wherein the slip stopper 34 and the buckling portion 253 match each other. In the first embodiment, the slip stopper 34 corresponding to the buckling portion 253 is two positioning blocks retained by the buckling portion 253. Moreover, depending on the quantity and type of the expansion apparatuses required by the server 30, the size of the frame 31 can be various. In order to improve the operating performance of the server 30, the frame 31 of the server 30 can accommodate many kinds of expansion apparatuses such as the tape unit 40. As such, the weight of the server 30 is gradually increased, and the burden of the frame 31 for carrying the tape unit 40 and various kinds of expansion apparatuses is also gradually added. Thus, the locking assembly 20 for fixing the tape unit 40 in the frame 31 may be affected by the whole weight. Especially during the transport process of the server 30, an impacting external force is usually exerted on the locking assembly 20, so the locking assembly 20 has to resist the damage of the impacting external force to ensure the tape unit 40 to be firmly fixed in the frame 31.

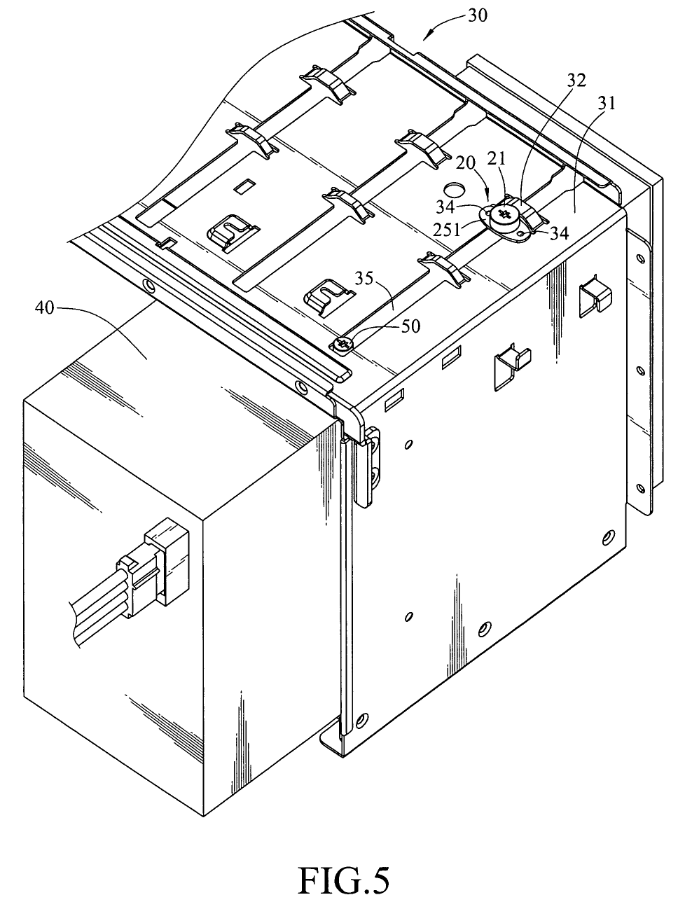

Please refer to FIG. 5 of a schematic view of an assembly process according to the first embodiment of the present invention. As shown in FIG. 5, when the tape unit 40 is desired to be installed on the frame 31, the tape unit 40 can gradually slip to a predetermined position along the chute 35 via the slipper 50 attached to the tape unit 40 till the slipper 50 moves to and stops at an end of the chute 35, and thus the tape unit 40 is positioned by slipping. In addition, both sides of the tape unit 40 require the same mechanism to be positioned by slipping.

After finishing positioning by slipping, the locking operation is started. The connector 21 of the locking assembly 20 respectively goes through the through hole 281 of the elastic component 28 and the through hole 252 of the gasket 25 with the thread portion 23, such that the connector 21, the gasket 25 and the elastic component 28 are combined with each other and then pass through the through hole 33 in the tape unit 40 again with the thread portion 23, thereby fixing the tape unit 40 in the frame 31. Moreover, there is a plurality of locking assemblies 20 disposed at a plurality of positions on both sides of the frame 31, for providing the locking force. After passing through, the gasket 25 is attached to the frame 31, and the bucking portion 253 retains the slip stopper 34, so as to prevent the cap portion 22 from moving along the surface of the frame 31. As such, the displacement of the connector 21 along the X, Y and Z axes can be limited simultaneously. Therefore, when an impacting external force is exerted on the locking assembly 20, the cap portion 22 has a better mechanical performance to resist the impacting force.

However, the retaining configuration of the gasket and the frame is not limited by the above description, so a second embodiment is disclosed accordingly. Moreover, when other embodiments of the present invention are illustrated, the elements identical to those in the first embodiment share the same reference numerals.

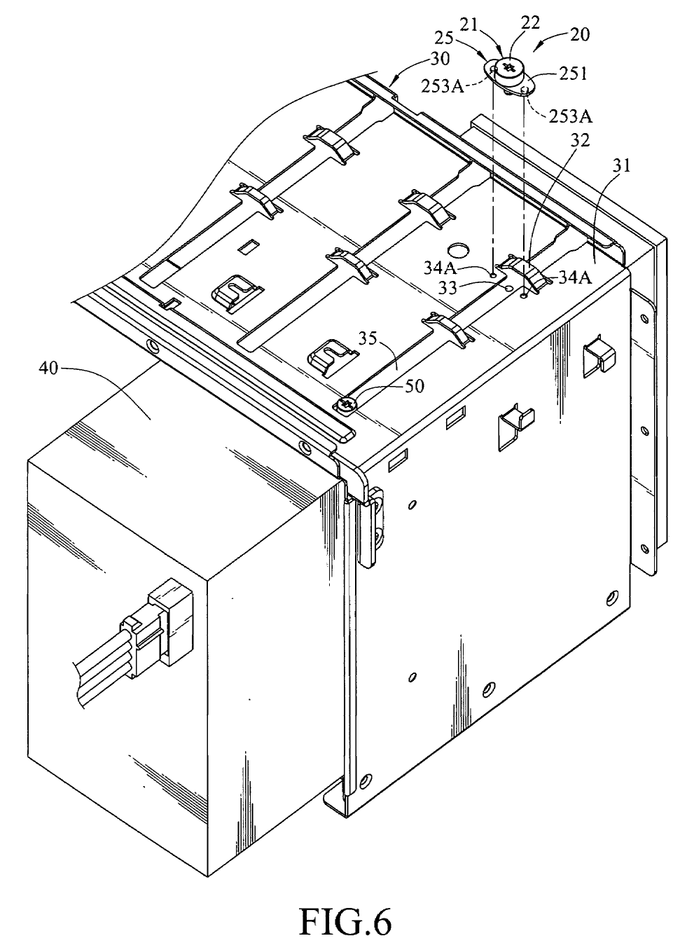

Please refer to FIG. 6 of the locking assembly 20 of a second embodiment of the present invention. The structure thereof is approximately the same as that of the first embodiment of the present invention. As shown in FIG. 6, the locking assembly 20 includes a connector 21, a gasket 25 and an elastic component 28. The connector 21 has a cap portion 22 and a thread portion 23 extending form the adjacent end of the cap portion 22. The gasket 25 has a stopper 251 and a through hole 252. The through hole 252 is fit on the thread portion 23 of the connector 21. After the thread portion 23 passes through, the stopper 251 lies between the target penetrated object and the cap portion 22. The difference between the second embodiment and the first embodiment is that in the second embodiment, a buckling portion 253A is disposed on each side of the stopper 251 corresponding to the through hole 252, and the buckling portion 253A is two positioning blocks. A slip stopper 34A of the frame 31 corresponding to the buckling portion 253A is two positioning holes. As such, after the connector 21 is locked on the frame 31 and the tape unit 40, the buckling portion 253A of the gasket 25 is retained by the slip stopper 34A, and the gasket 25 is attached to the frame 31 to serve as a buffer between the frame 31 and the cap portion 22.

In the present invention, the slip stopper is disposed on the frame of the server, and the buckling portion matching the slip stopper is disposed on the gasket, so as to limit the displacement of the connector in three moving directions, and thus prevent the connector from slipping and loosening under impact, thereby ensuring the normal operation of the server. The gasket has a large pressure area to protect the surface of the frame from being damaged, and meanwhile make it easy for the assembly process of tightening and loosening the connector without being stuck by the oversized through hole or the surface terrain. Moreover, an elastic component is fit on the connector to improve the mechanical strength, so as to enhance the locking power of the connector and thus raise the endurance of the whole connector assembly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A locking assembly, for fixing an object to a frame with a slip stopper, comprising:
a gasket, having a stopper, wherein the stopper has a buckling portion matching the slip stopper; and
a connector, having a cap portion and a thread portion extending from an end of the cap portion, wherein the thread portion goes through the gasket and into the frame and the object, so as to make the buckling portion and the slip stopper engage each other for fixing the object.

2. The locking assembly as claimed in claim 1, wherein an elastic component is further fit between the connector and the gasket.

3. The locking assembly as claimed in claim 1, wherein the slip stopper is a plurality of positioning blocks, and the slip stopper corresponding to each positioning block is a plurality of positioning holes.

4. The locking assembly as claimed in claim 1, wherein the first slip stopper is a plurality of positioning holes, and the slip stopper corresponding to each positioning hole is a plurality of positioning blocks.

5. The locking assembly as claimed in claim 1, wherein the diameter of the cap portion is larger than that of the thread portion.

6. The locking assembly as claimed in claim 1, wherein the diameter of the gasket is larger than that of the cap portion.
